(19) United States
(12) Patent Application Publication
(10) Pub. No.: US 2007/0145171 A1
(43) Pub. Date: Jun. 28, 2007

(54) Rebar cutting shears

(75) Inventors: Mark D. Rafn, Two Harbors, MN (US); Uwe P. Kausch, Duluth, MN (US); Clayton P. Sederberg, Duluth, MN (US)

Correspondence Address: PILLSBURY WINTHROP SHAW PITTMAN, LLP, P.O. BOX 10500, MCLEAN, VA, 22102, US

(73) Assignee: THE STANLEY WORKS, New Britain, CT (US)

(21) Appl. No.: 11/315,296

(22) Filed: Dec. 23, 2005

(51) Int. Cl. B02C 1/06

(52) U.S. Cl. 241/101.73

(57) ABSTRACT

A demolition/scrap processing shears assembly includes pivotally connected jaws. The first jaw has first and second laterally-spaced shearing edges. The second jaw has third and fourth laterally-spaced shearing edges. The first and second shearing edges have a plurality of staggered shearing apexes that sequentially shearingly mate with the third and fourth shearing edges, respectively, as the shear assembly closes. As viewed from the side, the third and fourth shearing edges are offset from each other such that the first and third shearing edges shearingly mate with each other asynchronously relative to the second and fourth shearing edges as the jaws close. Staggering the shearing apexes and offsetting the shearing action of the left and right side of the shear assembly reduces the power that an actuator must generate to shear processed material.

### BACKGROUND OF THE INVENTION

1. Field of the Invention

The invention relates to heavy-duty demolition and scrap processing shears for use in connection with machinery such as excavators. More particularly, the invention relates to the shapes and relative positions of the shearing edges of such shears.

2. Description of Related Art

Various conventional scrap processing shears are designed to cut a length of material such as rebar into smaller pieces that increase the value of the processed material and/or facilitate more compact storage of such material. For example, WO 2004/013417 discloses rebar cutting shears that include three laterally-spaced sets of shearing blades/edges that can shear a length of material in three different places with each stroke of the shears. The upper and lower jaws of the shears each form a shearing apex that collects/consolidates processed material before cutting the material. When a large number amount of material (e.g., numerous lengths of rebar) is to be cut in a single stroke, the material collects at the shearing apex and increases the amount of force that the shears must exert to simultaneously cut the consolidated material. Accordingly, a high-force hydraulic cylinder must be used to effectively power the shears. There remains a need for scrap processing/demolition shears that can more efficiently process material.

### BRIEF SUMMARY OF THE INVENTION

An aspect of one or more embodiments of the present invention provides shears that require less force to process more material per stroke of the shears.

Another aspect of one or more embodiments of the present invention provides shears that are inexpensive, durable, and versatile.

Another aspect of one or more embodiments of the present invention provides shears that facilitate the efficient and profitable processing of rebar.

Another aspect of one or more embodiments of the present invention provides shears that are easily adapted for use on existing machinery such as excavators. The shears efficiently utilize the power generated from the excavator's bucket linkage.

Another aspect of one or more embodiments of the present invention provides shears with left and right laterally-spaced sets of shearing blades. Each set of shearing blades/edges has a plurality of staggered shearing apexes that sequentially shear portions of the processed material. The left set of shearing blades may shearingly mate with each other asynchronously relative to the right set of shearing blades.

Another aspect of one or more embodiments of the present invention provides a shears assembly that includes first and second jaws operatively connected to each other for relative movement between open and closed positions; first and second laterally-spaced shearing edges disposed on the first jaw, the first shearing edge forming a first plurality of shearing apexes; and third and fourth laterally-spaced shearing edges disposed on the second jaw. The first and third shearing edges shearingly mate with each other when the jaws close. The second and fourth shearing edges shearingly mate with each other when the jaws close.

According to a further aspect of one or more of these embodiments, the second shearing edge forms a second plurality of shearing apexes.

According to a further aspect of one or more of these embodiments, the fourth shearing edge forms a second plurality of shearing apexes.

According to a further aspect of one or more of these embodiments, one of the second and fourth shearing edges forms a second plurality of shearing apexes. The assembly may also include at least one blade insert removably mounted to the first jaw and having the first shearing edge disposed thereon; at least one blade insert removably mounted to the first jaw and having the second shearing edge disposed thereon; at least one blade insert removably mounted to the second jaw and having the third shearing edge disposed thereon; and at least one blade insert removably mounted to the second jaw and having the fourth shearing edge disposed thereon.

According to a further aspect of one or more of these embodiments, the first plurality of shearing apexes sequentially mate with the third shearing edge when the jaws close. The second plurality of shearing apexes of the one of the second and fourth shearing edges may sequentially mate with the other of the second and fourth shearing edges when the jaws close.

According to a further aspect of one or more of these embodiments, the first, second, third, and fourth shearing edges are positioned such that the first and third shearing edges shearingly mate with each other before the second and fourth shearing edges shearingly mate with each other as the jaws close.

According to a further aspect of one or more of these embodiments, the first, second, third, and fourth shearing edges are positioned such that the first and third shearing edges shearingly mate with each other asynchronously relative to when the second and fourth shearing edges shearingly mate with each other as the jaws close.

According to a further aspect of one or more of these embodiments, as the jaws move from the open to the closed position, each of the first plurality of shearing apexes shearingly mates with the third shearing edge before any of the second plurality of shearing apexes of the one of the second and fourth shearing edges shearingly mates with the other of the second and fourth shearing edges.

According to a further aspect of one or more of these embodiments, as viewed from a side, the first and second shearing edges are offset relative to each other.

Additionally and/or alternatively, as viewed from a side, the third and fourth shearing edges are offset relative to each other.

According to a further aspect of one or more of these embodiments, the assembly is constructed and arranged to be mounted to an excavator having a bucket cylinder, wherein one of the jaws is constructed and arranged to operatively connect to the bucket cylinder such that operation of the bucket cylinder opens and closes the jaws.

According to a further aspect of one or more of these embodiments, the assembly includes raking tines mounted to one of the first and second jaws.

According to a further aspect of one or more of these embodiments, the first and second shearing edges are laterally spaced from each other by at least 10 inches.

Another aspect of one or more embodiments of the present invention provides a shears assembly that includes first and second jaws operatively connected to each other for relative movement between open and closed positions; first and second laterally-spaced shearing edges disposed on the first jaw, the first shearing edge forming first and second shearing apexes; and third and fourth laterally-spaced shearing edges disposed on the second jaw. One of the second and fourth shearing edges form a third shearing apex. The first and third shearing edges shearingly mate with each other when the jaws move from the open position to the closed position. The second and fourth shearing edges shearingly mate with each other when the jaws move from the open position to the closed position. The first, second, and third shearing apexes are positioned to each shearingly mate with its respective opposing shearing edge at different times as the jaws move from the open position to the closed position.

According to a further aspect of one or more of these embodiments, the one of the second and fourth shearing edges forms a fourth shearing apex. The first, second, third, and fourth shearing apexes are positioned to each shearingly mate with its respective opposing shearing edge at different times as the jaws move from the open position to the closed position.

According to a further aspect of one or more of these embodiments, the first shearing edge forms fourth and fifth shearing apexes. The first, second, third, fourth, and fifth apexes are positioned to each shearingly mate with its respective opposing shearing edge at different times as the jaws move from the open position to the closed position.

According to a further aspect of one or more of these embodiments, the one of the second and fourth shearing edges forms sixth, seventh, and eighth shearing apexes. The first, second, third, fourth, fifth, sixth, seventh, and eighth shearing apexes are positioned to each shearingly mate with its respective opposing shearing edge at different times as the jaws move from the open position to the closed position.

Another aspect of one or more embodiments of the present invention provides a shears assembly that includes first and second jaws operatively connected to each other for relative movement between open and closed positions; first and second laterally-spaced shearing edges disposed on the first jaw; third and fourth laterally-spaced shearing edges disposed on the second jaw; and raking tines mounted to the first jaw. The first and third shearing edges shearingly mate with each other when the jaws close. The second and fourth shearing edges shearingly mate with each other when the jaws close.

Another aspect of one or more embodiments of the present invention provides a shears assembly comprising first and second jaws operatively connected to each other for relative movement between open and closed positions; a first pair of interacting shearing edges disposed on the first and second jaws, respectively; and a second pair of interacting shearing edges disposed on the first and second jaws, respectively. One of the first pair of interacting shearing edges has a first plurality of shearing apexes. One of the second pair of interacting shearing edges has a second plurality of shearing apexes. The second pair of interacting shearing edges are laterally spaced from the first pair of interacting shearing edges.

According to a further aspect of one or more of these embodiments, the first and second pairs of interacting shearing edges are positioned to shearingly interact in a sequential order as the jaws close.

According to a further aspect of one or more of these embodiments, the first and second pairs of interacting shearing edges are positioned to asynchronously shearingly interact as the jaws close.

According to a further aspect of one or more of these embodiments, the first pair of interacting shearing edges are positioned to interact for cutting prior to said second pair of interacting shearing edges.

Another aspect of one or more embodiments of the present invention provides a shears assembly that includes first and second jaws operatively connected to each other for relative movement between open and closed positions; first and second laterally-spaced shearing edges disposed on the first jaw; third and fourth laterally-spaced shearing edges disposed on the second jaw; and a plurality of shearing apexes formed on one of the shearing edges. The first and third shearing edges shearingly mate with each other when the jaws close. The second and fourth shearing edges shearingly mate with each other when the jaws close. As viewed from a side, the first and second shearing edges are offset relative to each other.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

Referring now to the drawings which from a part of this original disclosure:

FIG. 1 is a perspective view of shears according to an embodiment of the present invention;

FIG. 2 is a side view of the shears in FIG. 1 mounted to a stick of an excavator;

FIG. 3 is a right side view of a lower jaw of the shears in FIG. 1 with the left side of the lower jaw shown in phantom dotted lines;

FIG. 4 is a cross-sectional view of the lower jaw of the shears in FIG. 1 taken along the line 4-4 in FIG. 3; and

FIG. 5 is a side view of the shears in FIG. 1 mounted to a stick.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

### DETAILED DESCRIPTION OF EMBODIMENTS OF THE INVENTION

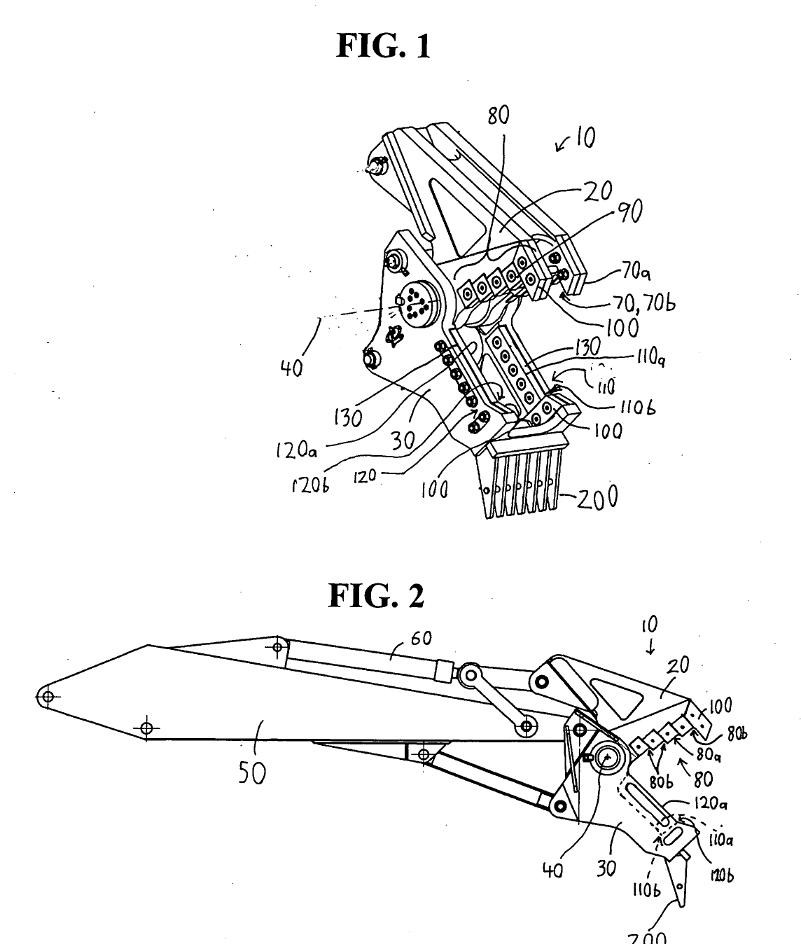

FIGS. 1-4 illustrate a heavy duty demolition/scrap processing shears assembly 10 according to an embodiment of the present invention. The assembly 10 includes upper and lower jaws 20, 30 that pivotally move relative to each other about an axis 40 between an open position (shown in FIGS. 1 and 2) and a closed position (not shown).

As shown in FIG. 2, the shears assembly 10 may be mounted to the articulating stick 50 of an excavator (or other machine). In the illustrated embodiment, the lower jaw 30 rigidly mounts to the stick 50. The upper jaw 20 operatively connects to a hydraulic bucket cylinder 60 and bucket linkage of the excavator to enable the machine to selectively pivot the upper jaw 20 relative to the lower jaw 30 to open and close the shear assembly 10. The lower jaw 20 could additionally or alternatively pivot relative to the stick 50.

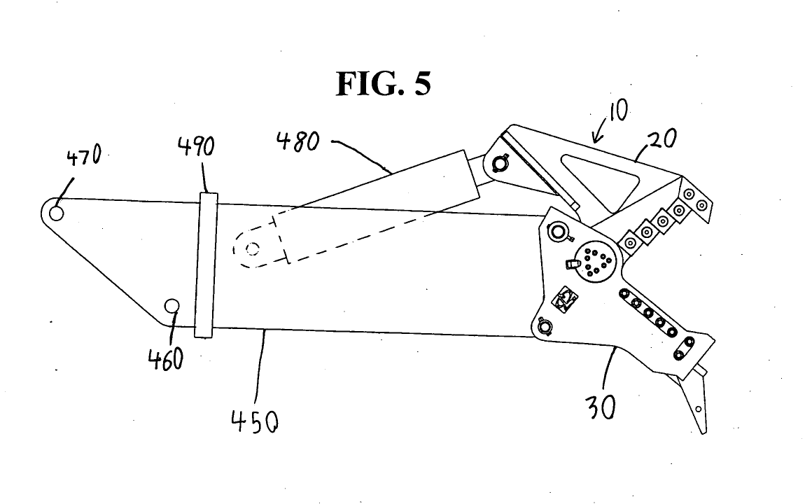

Alternatively, as shown in FIG. 5, the shears assembly 10 may mount to a stick 450 that is constructed and arranged to mount to an excavator (or other machine) in place of the excavator's own stick. The stick 450 pivotally mounts to a boom of the excavator via a mounting hole 460. The stick 450 pivotally connects to the excavator's stick-controlling cylinder via a mounting hole 470 to enable the excavator to selectively pivot the stick 450 relative to the excavator's boom. The lower jaw 30 rigidly mounts to the stick 450. The stick 450 includes a 360 degree rotation coupling 490 that enables an operator to selectively rotate the forward part of the stick 450 and shears assembly 10 relative to a rearward part of the stick 450 about a longitudinal axis of the stick 450.

A hydraulic cylinder 480 operatively extends between the stick 450 and the upper jaw 20 to actuate the upper jaw 20. The hydraulic cylinder 480 shown in FIG. 5 may have a larger working diameter than the bucket cylinder 60, which is typically about 6-7 inches. For example, the working diameter of the cylinder 480 may be 8-20 inches, 10-18 inches, 12-16 inches, approximately 14 inches, etc. The hydraulic cylinder 480 may therefore increase the shearing force generated by the shears assembly 10 relative to the embodiment shown in FIG. 2.

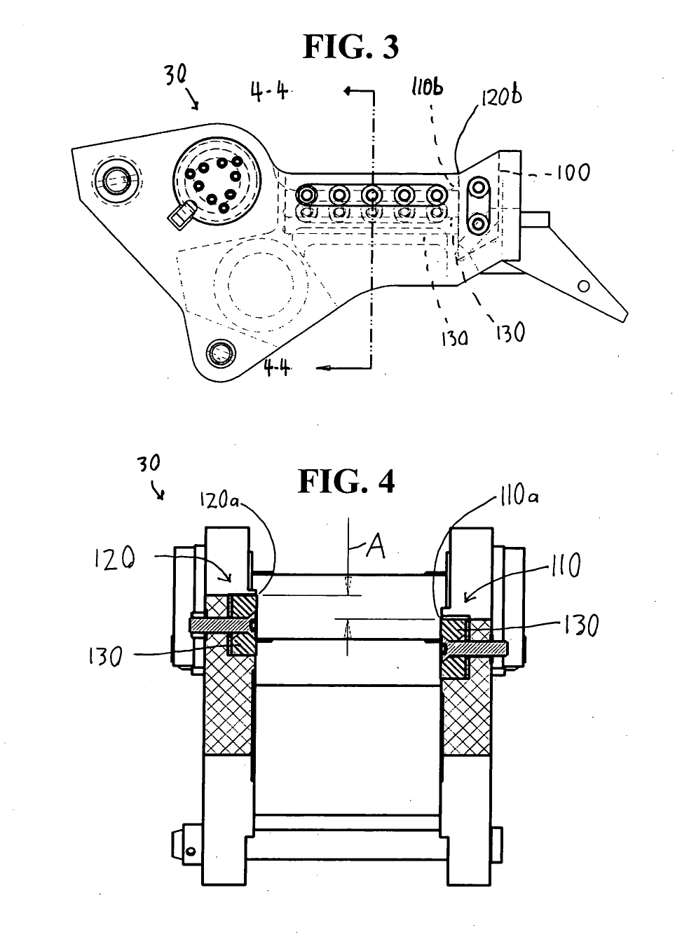

Returning to FIG. 1, the upper jaw 20 includes left and right laterally-spaced shearing blade assemblies 70, 80. Each shearing blade assembly 70, 80 comprises four square blade inserts 90 and one parallelogram blade insert 100 that are bolted or otherwise fastened to the remainder of the upper jaw 20. Similarly, as shown in FIGS. 1 and 3, the lower jaw 30 includes left and right laterally-spaced shearing blade assemblies 110, 120. Each shearing blade assembly 110, 120 comprises a rectangular blade insert 130 and a parallelogram blade insert 100 that are bolted or otherwise fastened to the remainder of the lower jaw 30.

Each shearing blade assembly 70, 80, 110, 120 may comprise a single integral blade insert or a plurality of blade inserts that are connected to each other (e.g., bolted, welded, integrally cast, etc.) before being mounted to the remainder of the jaw 20, 30. For example, the shearing blade assemblies 70, 80 may each comprise an integral blade insert that includes serrations that define the shearing apexes. Each shearing blade assembly 70, 80, 110, 120 may comprise greater or fewer blade inserts and/or may comprise blade inserts having alternative shapes (e.g., rectangular, trapezoidal, quadrilateral) without departing from the scope of the present invention. The shearing blade assemblies 70, 80, 110, 120 may be integrally formed with their respective jaws 20, 30 without departing from the scope of the present invention. The jaws 20, 30 preferably have seating surfaces against which the blade inserts 90, 100, 130 seat to strengthen the connection between such inserts 90, 100, 130 and the remainder of the jaws 20, 30.

The blade inserts 90, 100, 130 are preferably indexable. The square shape of the insert 90 provides four shearing edges on each lateral side of the insert 90 such that each insert 90 may be repositioned (e.g., rotated and/or flipped) to provide up to eight shearing edges as each shearing edge becomes dull. Similarly, the rectangular shape of the insert 130 provides two usable shearing edges on each lateral side thereof, which can be used by rotating and/or flipping the insert 130. Similarly, the parallelogram shape of the blade insert 100 provides two shearing edges on each lateral side of the insert 100. For example, the insert 100 on the upper right shearing blade assembly 80 may be rotated 180 degrees to provide a fresh shearing edge. Similarly, the insert 100 from the upper right shearing blade assembly 80 may be moved to the lower right shearing blade assembly 120 so that the fresh shearing edges on the opposite lateral side of the insert 100 may be used.

As shown in FIG. 1, each shearing blade assembly 70, 80, 110, 120 defines a shearing edge 70a, 80a, 110a, 120a. The upper left and right shearing edges 70a, 80a shearingly mate with the lower left and right shearing edges 110a, 120a, respectively, when the upper jaw moves from its open position to its closed position. As used herein, shearingly mating means that shearing edges move past each other as viewed from the side (i.e., along the axis 40). As would be understood by one of ordinary skill in the art, shearing edges need not touch to shearingly mate with each other, but merely come close enough to each other to tend to shear processed material disposed between the shearing edges.

As shown in FIGS. 1 and 2, each upper shearing edge 70a, 80a forms a plurality of staggered shearing apexes 70b, 80b as the shearing edge 70a, 80a progresses away from the axis 40. In the illustrated embodiment, the shearing apexes 70b, 80b are formed at the intersections of adjacent blade inserts 90, 100, but may alternatively be formed entirely by a single blade insert without departing from the scope of the present invention. As defined herein, a shearing apex 70b, 80b shearingly mates with a corresponding shearing edge 10a, 120a on the lower jaw 30 when the apex 70b, 80b entirely passes by the corresponding shearing edge 110a, 120a as viewed from the side (i.e., along the axis 40) as the jaws 20, 30 move into the closed position. While the illustrated shearing apexes 70b, 80b are defined at the points of angles in the shearing edges 70a, 80a, the apexes 70b, 80b may alternatively having any other suitable shape (e.g., concave curve, etc.). As the jaws 20, 30 close, each apex 70b becomes part of a different closed-perimeter opening (as viewed from the side) defined by the shearing edges 70a, 110a. Each closed-perimeter opening disappears when the included apex 70b shearingly mates with the shearing edge 110a.

As shown in FIGS. 1-3, the lower shearing edges 110a, 120a each include only one shearing apex 110b, 120b. Greater or fewer shearing apexes may be provided on the shearing edges 70a, 80a, 110a, 120a without departing from the scope of the present invention.

In the illustrated embodiment, the plurality of shearing apexes 70b, 80b are shaped and arranged to divide processed material (such as rebar) into the plurality of apexes 70b, 80b as the assembly 10 moves toward its closed position. In conventional single-apex shears, processed material collects at the single apex and increases the force required to shear such material all at once. In the illustrated embodiment of the present invention, however, as the upper jaw 20 moves toward its closed position, the apexes 80b sequentially shearingly mate with the shearing edge 120a and sequentially shear portions of processed material in each apex 80b, which reduces the force that the cylinder 60 must generate at any given angular position of the upper jaw 20 to shear the processed material.

As best shown in FIGS. 3 and 4, the shearing edges 110a, 120a on the lower jaw 30 are offset from each other as viewed from the side (i.e., along the axis 40) by a distance A (see FIG. 4). In the illustrated embodiment, the shearing edge 110a is disposed farther from the shearing edge 70a than the shearing edge 120a is spaced from the shearing edge 80a. Consequently, as the upper jaw 20 closes, the shearing apexes 80b shearingly mate with the shearing edge 120a before the shearing apexes 70b shearingly mate with the shearing edge 110a. Offsetting the left set of shearing blades 70, 110 from the right set of shearing blades 80, 120 reduces the force that the cylinder 60 must generate to shear the processed material relative to prior art shears that synchronously shearingly mate left and right sets of shearing blades.

In the illustrated embodiment, the lower shearing edges 110a, 120a are offset from each other. However, the upper shearing edges 70a, 80a could alternatively or additionally be offset relative to each other as viewed from the side, without deviating from the scope of the present invention.

In the embodiment illustrated in FIGS. 1-4, the shearing edges 70a, 80a are translationally offset from each other but remain parallel to each other. Alternatively, the shearing edges 70a, 80a may be offset relative to each other as a result of an angle formed between the edges 70a, 80a as viewed from the side. For example, as viewed from the side, the edges 70a, 80a could intersect each other toward a rearward end of the edges 70a, 80a and diverge from each other toward a forward end of the edges 70a, 80a. Alternatively, the offset between the edges 70a, 80a may result from a combination of translational and angular offsets between the edges 70a, 80a.

In the illustrated embodiment, the shearing edges 110a, 120a are sufficiently offset from each other that every apex 80b shearingly mates with the shearing edge 120a before any of the shearing apexes 70b shearingly mate with the shearing edge 110a. However, the degree of offset may be modified in any suitable manner without deviating from the scope of the present invention. For example, the offset may be designed such that the innermost shearing apex 70b shearingly engages the shearing edge 110a before the outermost shearing apex 80b shearingly engages the shearing edge 120a. According to another embodiment of the present invention, the offset causes the sequential shearing action of the apexes 80b to be 180 degrees out of phase with the shearing action of the apexes 70b. Consequently, the apexes 70b, 80b sequentially shearingly mate with the shearing edges 110a, 120a in the following asynchronous order as the upper jaw 20 closes: (1) one or more initial apexes 80b, (2) one or more initial apexes 70b, (3) additional one or more apexes 80b, (4) additional one or more apexes 70b, etc.

The angular positions at which the shearing apexes 80b shearingly mate with the shearing edge 120a may be designed to specifically control the angular timing of the sequential mating of the apexes 80b with the shearing edge 120a. The angular offset and staggering of the apexes 70b, 80b is preferably designed so that no two apexes 70b, 80b simultaneously shearingly engage the lower jaw 20. Accordingly, at any given angular position of the upper jaw 20 relative to the lower jaw 30, the shearing force is focused on a single apex 70b, 80b, which efficiently utilizes the power of the cylinder 60. However, according to an alternative embodiment of the present invention, two or more apexes 70b, 80b simultaneously shearingly mate with the lower jaw. For example, an apex 70b and an apex 80b could simultaneously shearingly mate with the lower jaw to balance the forces on the left and right sides of the assembly 10.

The combination of radially-staggered shearing apexes 70b, 80b and asynchronous left and right side shearing advantageously reduces the power that the cylinder 60 must generate to shear the processed material. Accordingly, according to an embodiment of the present invention, the reduced cylinder force required enables existing bucket cylinders of excavators to power the shear assembly 10. Conversely, the combination enables a weaker cylinder 60 to process more material per stroke. The reduced force required reduces wear and tear on the assembly 10, cylinder 60, cylinder's hydraulic circuit, and the excavator or other machine.

In the illustrated embodiment, the shearing edges 70a, 80a are laterally spaced by about 18 inches. Accordingly, processed material that is sheared by the assembly 10 and lays in a perfectly lateral direction (i.e., parallel to the axis 40) will be sheared into 18 inch lengths. However, any other lateral gap (e.g., 10 inches, 12 inches, 24 inches, etc.) may be used to shear processed material into any desired length without deviating from the scope of the present invention. According to another embodiment, the gap is greater than 10 inches.

While the illustrates shears assembly 10 includes two sets of laterally spaces shearing blades, additional sets of laterally spaced shearing blades could additionally be provided to further process the material during each stroke of the shears assembly 10.

A raking tine 200 mounts to the lower jaw 30. When processing material such as rebar, the raking tine 200 enables a machine operator to quickly switch between positioning/arranging/moving processed material and shearing such processed material.

The illustrated shears assembly 10 is well suited to process rebar. However, the shears assembly 10 may additionally or alternatively be used to process any other type of material (e.g., scrap metal, concrete, ferrous cable, non-ferrous cable, etc.) without deviating from the scope of the present invention.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

What is claimed is:

1. A shears assembly comprising:
first and second jaws operatively connected to each other for relative movement between open and closed positions;
first and second laterally-spaced shearing edges disposed on the first jaw, the first shearing edge forming a first plurality of shearing apexes; and
third and fourth laterally-spaced shearing edges disposed on the second jaw, the first and third shearing edges shearingly mating with each other when the jaws close, the second and fourth shearing edges shearingly mating with each other when the jaws close.

2. The assembly according to claim 1, wherein the second shearing edge forms a second plurality of shearing apexes.

3. The assembly according to claim 1, wherein the fourth shearing edge forms a second plurality of shearing apexes.

4. The assembly according to claim 1, wherein one of the second and fourth shearing edges forms a second plurality of shearing apexes.

5. The assembly according to claim 4, further comprising:
at least one blade insert removably mounted to the first jaw and having the first shearing edge disposed thereon;
at least one blade insert removably mounted to the first jaw and having the second shearing edge disposed thereon;
at least one blade insert removably mounted to the second jaw and having the third shearing edge disposed thereon; and
at least one blade insert removably mounted to the second jaw and having the fourth shearing edge disposed thereon.

6. The assembly according to claim 4, wherein the first plurality of shearing apexes sequentially mate with the third shearing edge when the jaws close.

7. The assembly according to claim 6, wherein the second plurality of shearing apexes of the one of the second and fourth shearing edges sequentially mates with the other of the second and fourth shearing edges when the jaws close.

8. The assembly according to claim 4, wherein the first, second, third, and fourth shearing edges are positioned such that the first and third shearing edges shearingly mate with each other before the second and fourth shearing edges shearingly mate with each other as the jaws close.

9. The assembly according to claim 4, wherein the first, second, third, and fourth shearing edges are positioned such that the first and third shearing edges shearingly mate with each other asynchronously relative to when the second and fourth shearing edges shearingly mate with each other as the jaws close.

10. The assembly according to claim 4, wherein, as the jaws move from the open to the closed position, each of the first plurality of shearing apexes shearingly mates with the third shearing edge before any of the second plurality of shearing apexes of the one of the second and fourth shearing edges shearingly mates with the other of the second and fourth shearing edges.

11. The assembly according to claim 4, wherein, as viewed from a side, the first and second shearing edges are offset relative to each other.

12. The assembly according to claim 4, wherein, as viewed from a side, the third and fourth shearing edges are offset relative to each other.

13. The assembly according to claim 4, wherein the assembly is constructed and arranged to be mounted to an excavator having a bucket cylinder, wherein one of the jaws is constructed and arranged to operatively connect to the bucket cylinder such that operation of the bucket cylinder opens and closes the jaws.

14. The assembly according to claim 4, further comprising raking tines mounted to one of the first and second jaws.

15. The assembly according to claim 4, wherein the first and second shearing edges are laterally spaced from each other by at least 10 inches.

16. A shears assembly comprising:
first and second jaws operatively connected to each other for relative movement between open and closed positions;
first and second laterally-spaced shearing edges disposed on the first jaw, the first shearing edge forming first and second shearing apexes; and
third and fourth laterally-spaced shearing edges disposed on the second jaw, one of the second and fourth shearing edges forming a third shearing apex,
the first and third shearing edges shearingly mating with each other when the jaws move from the open position to the closed position,
the second and fourth shearing edges shearingly mating with each other when the jaws move from the open position to the closed position,
the first, second, and third shearing apexes being positioned to each shearingly mate with its respective opposing shearing edge at different times as the jaws move from the open position to the closed position.

17. The assembly of claim 16, wherein the one of the second and fourth shearing edges forms a fourth shearing apex, the first, second, third, and fourth shearing apexes being positioned to each shearingly mate with its respective opposing shearing edge at different times as the jaws move from the open position to the closed position.

18. The assembly of claim 16, wherein the first shearing edge forms fourth and fifth shearing apexes, the first, second, third, fourth, and fifth apexes being positioned to each shearingly mate with its respective opposing shearing edge at different times as the jaws move from the open position to the closed position.

19. The assembly of claim 18, wherein the one of the second and fourth shearing edges forms sixth, seventh, and eighth shearing apexes, the first, second, third, fourth, fifth, sixth, seventh, and eighth shearing apexes being positioned to each shearingly mate with its respective opposing shearing edge at different times as the jaws move from the open position to the closed position.

20. A shears assembly comprising:
first and second jaws operatively connected to each other for relative movement between open and closed positions;
first and second laterally-spaced shearing edges disposed on the first jaw;
third and fourth laterally-spaced shearing edges disposed on the second jaw, the first and third shearing edges shearingly mating with each other when the jaws close, the second and fourth shearing edges shearingly mating with each other when the jaws close; and
raking tines mounted to the first jaw.

21. A shears assembly comprising:
first and second jaws operatively connected to each other for relative movement between open and closed positions;
a first pair of interacting shearing edges disposed on the first and second jaws, respectively, one of the first pair of interacting shearing edges having a first plurality of shearing apexes; and
a second pair of interacting shearing edges disposed on the first and second jaws, respectively, one of the second pair of interacting shearing edges having a second plurality of shearing apexes, the second pair of interacting shearing edges being laterally spaced from the first pair of interacting shearing edges.

22. The assembly of claim 21, wherein the first and second pairs of interacting shearing edges are positioned to shearingly interact in a sequential order as the jaws close.

23. The assembly of claim 21, wherein the first and second pairs of interacting shearing edges are positioned to asynchronously shearingly interact as the jaws close.

24. The assembly of claim 21, wherein the first pair of interacting shearing edges are positioned to interact for cutting prior to said second pair of interacting shearing edges.

25. A shears assembly comprising:
first and second jaws operatively connected to each other for relative movement between open and closed positions;
first and second laterally-spaced shearing edges disposed on the first jaw;
third and fourth laterally-spaced shearing edges disposed on the second jaw, the first and third shearing edges shearingly mating with each other when the jaws close, the second and fourth shearing edges shearingly mating with each other when the jaws close; and
a plurality of shearing apexes formed on one of the shearing edges,
wherein, as viewed from a side, the first and second shearing edges are offset relative to each other.
